(19) United States
(12) Patent Application Publication
(10) Pub. No.: US 2009/0217304 A1
(43) Pub. Date: Aug. 27, 2009

(54) Method of Switching Functions of a Device without Attaching and Detaching the Device

(76) Inventors: Po-Chuan Shih, Taipei City (TW); Chen-Pang Hsu, Taipei City (TW)

Correspondence Address: NORTH AMERICA INTELLECTUAL PROPERTY CORPORATION, P.O. BOX 506, MERRIFIELD, VA, 22116, US

(21) Appl. No.: 12/115,541

(22) Filed: May 5, 2008

(30) Foreign Application Priority Data
Feb. 21, 2008 (CN) 200810080841.2

(51) Int. Cl. G06F 9/44

(52) U.S. Cl. 719/321

(57) ABSTRACT

According to different VID/PIDs stored in a device descriptor of a USB composite device, various functions and corresponding drivers are assigned and switched. Therefore, the switches of functions are achieved without detaching and attaching the USB composite device. Possible problems while switching operation systems of different platforms are overcome. And the high cost in embedding various drivers into a mainframe is reduced.

### BACKGROUND OF THE INVENTION

1. Field of the Invention

The present invention relates to a method of switching functions of a device, and more particularly, to a method of switching functions of a device without attaching and detaching the device.

2. Description of the Prior Art

In Universal Serial Bus (USB) specifications, each peripheral device connected to the USB acquires an endpoint address, and communications between a mainframe and an endpoint are established through virtual pipes. Therefore, after a virtual pipe has been established, each endpoint returns a descriptor to both the USB and the mainframe (or an operating system of the mainframe) so that the mainframe perceives information related to each peripheral device. Information carried in the descriptor and related to a corresponding peripheral device includes class properties, a transmission category, a maximum package size, and a bandwidth.

For describing different types of data, different types of descriptors are required. Conventional USB descriptors include device descriptors, configuration descriptors, interface descriptors, and endpoint descriptors. Moreover, a device descriptor may be used for setting numbers of configuration descriptors, interface descriptors, and endpoint descriptors, and for setting other information. Therefore, each peripheral device has a unique device descriptor. When a specific peripheral device is required to be used, and when the peripheral device is attached to the USB, the operating system has to search for an appropriate driver for the peripheral device. At this time, a VID (Vendor Identification)/PID (Product Identification) field of the device descriptor of the peripheral device is utilized to determine an appropriate driver for the operating system, such as in a Microsoft operating system, which may include a library of installation information files having a filename extension “.inf”. While the peripheral device is attached to the USB, the Microsoft operating system has to search for an information file having a same VID/PID as the VID/PID of the descriptor of the peripheral device from among the library of installation information files, so as to find an appropriate driver for the peripheral device.

However, as variety of functions of the peripheral device grows, types of the peripheral device installed with a plurality of functions increase as well. The peripheral device having multiple functions and cooperating with the USB is conventionally called a “USB composite device.” Certain USB composite devices may not be supported by drivers provided by the Microsoft operating system, and therefore, installation of other appropriate drivers may be required to support such USB composite devices. Note that since available drivers of such USB composite devices are supplied by vendors other than the Microsoft, the available drivers may be called “vendor-supplied drivers,” whereas the drivers supplied by Microsoft are called “MS-supplied drivers.”

Please refer to FIG. 1 and FIG. 2, both of which are schematic diagrams illustrating installation of original settings through a graphical user interface (GUI) corresponding to vendor-supplied drivers where settings of a peripheral device are conventionally required to be changed, i.e. schematic diagrams of layers between a mainframe and the peripheral device. As shown in FIG. 1 and FIG. 2, a vendor-supplied graphical user interface (Vendor-supplied GUI) 102 is used for establishing communications between a user and an operating system 104 so that the user may manipulate operations of a USB composite device 110. The operating system 104 is installed with MS-supplied drivers 106 and vendor-supplied drivers 108 so as to activate different functions of the USB composite device 110. The USB composite device 110 includes a device descriptor region 112, an additional descriptor region 114, a reserved region 116, a first function region 118, and a second function region 120. The device descriptor region 112 is installed with the device descriptor of the USB composite device 110. The additional descriptor region 114 is installed with descriptors other than the device descriptor, such as the configuration descriptors, the interface descriptors, and the endpoint descriptors, where the descriptors installed in the additional descriptor region 114 are controlled by the device descriptor within the device descriptor region 112. The reserved region 116 stores other information about the USB composite device 110. Drivers currently used by the USB composite device 110 are mounted in both the first function region 118 and the second function region 120. For example, as illustrated in FIG. 1, a video recording driver mounted in the first function region 118 malfunctions, and an audio driver is mounted in the second function region 120. At this time, a researcher or a user may have to remove the video recording function from the first function region 118, and subsequently reload a video driver of an original version into the first function region 118 through either an MS-supplied driver 106 or a vendor-supplied driver 108. However, the USB composite device 110 has to be detached and attached once from the USB at the same time. As shown in FIG. 2, after the USB composite device 110 is re-attached to the USB, the researcher or the user may remount the original video driver by operating the vendor-supplied GUI 102. As illustrated in FIG. 1 and FIG. 2, though the user or the researcher may restore functions of the USB composite device 110, i.e. the peripheral device, by removing and remounting drivers, at least one cycle of detaching and attaching the peripheral device for the USB is required, and inconveniences arise.

In certain conventional techniques, drivers may still be updated without attaching and detaching the peripheral device. In the certain conventional techniques, integrated circuits corresponding to different functions are integrated into one single integrated circuit, and the single integrated circuit is embedded into the mainframe so as to form a built-in hub. However, high fabrication costs are required in such conventional techniques, and under mass production, the conventional techniques are not attractive to common users as well.

### SUMMARY OF THE INVENTION

The present invention discloses a method of switching functions of a device without attaching and detaching the device. The method is applied on a condition that the device has been attached on a universal serial bus (USB). The method comprises selecting a VID/PID according to a device selection command, a descriptor of the device, and a plurality of VID/PIDs, and selecting a driver corresponding to the selected VID/PID; determining whether the selected driver is a local driver or an external driver; activating or deactivating a function of the device through commands corresponding to the local driver while the selected driver is the local driver; determining a medium for reconfiguring the descriptor according to the device selection command; and reconfiguring the descriptor according to the activated or deactivated function. The activated or deactivated function is selected according to the device selection command.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 and FIG. 2 are schematic diagrams of installing original settings through a graphical user interface corresponding to vendor-supplied drivers while settings of a peripheral device are conventionally required to be changed.

FIG. 3 is a flowchart of the disclosed method of switching functions of a device without attaching and detaching the device in the present invention, where the disclosed method is applied on a peripheral device attached to the USB.

FIG. 4, FIG. 5, FIG. 6, and FIG. 7 are diagrams illustrating a condition in which the vendor-supplied driver is determined to be the medium for switching functions of a device according to the disclosed method shown in FIG. 3.

FIG. 8 is a diagram of a vendor-supplied GUI according to both the disclosed method shown in FIG. 3 and a preferred embodiment of the present invention.

### DETAILED DESCRIPTION

For neutralizing defects including high fabrication costs and the at least one cycle of detaching and attaching the peripheral device, a method of switching functions of a device without attaching and detaching the device is disclosed in the present invention. Characteristics of the disclosed method include correlating different functions of the peripheral device (or switching different combinations of the functions) to at least one VID/PID in the device descriptor of the peripheral device, and switching the correlated functions (or switching correlated combinations of the functions) of the peripheral device by switching different VID/PIDs.

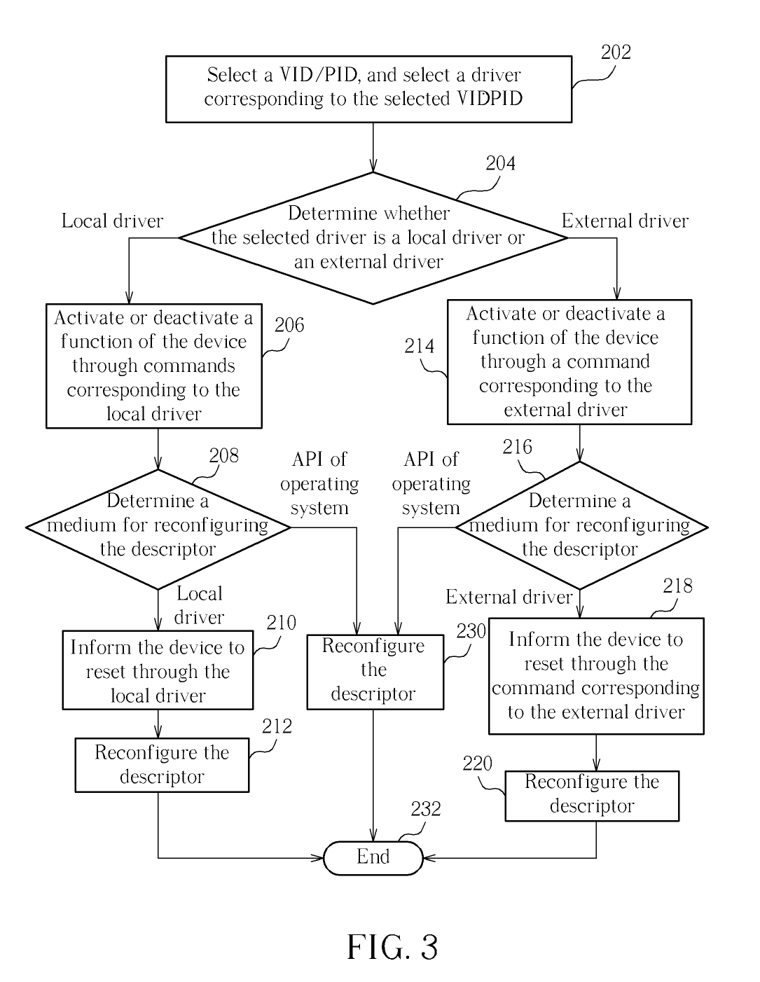

Please refer to FIG. 3, which is a flowchart of the disclosed method of switching functions of a device without attaching and detaching the device in the present invention, where the disclosed method is applied in a peripheral device attached to the USB. As shown in FIG. 3, the disclosed method of switching functions of the device includes steps as follows:

Step 202: Select a VID/PID according to a device selection command, a descriptor of the device, and a plurality of VID/PIDs of the device, and select a driver corresponding to the selected VID/PID;

Step 204: Determine whether the selected driver is a local driver or an external driver; when the driver is determined to be a local driver, go to Step 206; else, go to Step 214;

Step 206: Activate or deactivate a function of the device through commands corresponding to the local driver when the driver is determined to be the local driver, where the activated or deactivated function is selected according to the device selection command;

Step 208: Determine a medium for reconfiguring the descriptor according to the device selection command; when the medium is determined to be the local driver, go to Step 210; else, when the medium is determined to be an application program interface (API) of an operating system, go to Step 230;

Step 210: Inform the device to reset through the local driver;

Step 212: Reconfigure the descriptor according to the activated or deactivated function;

Step 214: Activate or deactivate a function of the device through a command corresponding to the external driver while the driver is the external driver, where the activated or deactivated function is selected according to the device selection command;

Step 216: Determine a medium for reconfiguring the descriptor according to the device selection command; when the medium is determined to be the command corresponding to the external driver, go to Step 218; else, when the medium is determined to be the application program interface of the operating system, go to Step 230;

Step 218: Inform the device to reset through the command corresponding to the external driver;

Step 220: Reconfigure the descriptor according to the activated or deactivated function;

Step 230: Reconfigure the descriptor according to both the application program interface of the operating system and the activated or deactivated function; and

Step 232: End.

Note that the device attached to the USB may be a peripheral device, which may be an image device, a mass storage device, an expansion device, or a composite device having at least two functions. When certain functions of the device malfunction, or when a user of the device tends to replace certain functions of the device, the user may initiate replacements of the certain functions of the device through a graphical user interface (GUI) provided by a vendor of the device, where the GUI is programmed according to the disclosed method of switching functions of the device in the present invention. In other words, the GUI may be regarded as a physical medium or tool for implementing a preferred embodiment of the present invention. The following descriptions are based on the above assumptions.

In Step 202, when certain functions of the device malfunction, or when the user tends to replace certain functions of the device, the user may issue a device selection command through the GUI for making required selections while replacing functions of the device. The GUI shows a plurality of VID/PIDs of the device, enables the user to select one VID/PID from the shown plurality of VID/PIDs, and enables the user to select drivers and functions corresponding to the selected VID/PID within the device.

In Step 204, a type of the selected driver has to be determined. Drivers related to the disclosed method of the present invention are classified into local drivers and external drivers. In a preferred embodiment of the present invention, the local driver is a driver installed on a mainframe using the Microsoft operating system, i.e. an MS-supplied driver, and the external driver is specifically provided and programmed by the vendor of the device for running the device, i.e. the vendor-supplied driver. In the following descriptions, the local driver is directly replaced by the MS-supplied driver, whereas the external driver is directly replaced by the vendor-supplied driver.

In Step 206, when the selected driver corresponding to the selected VID/PID is determined to be an MS-supplied driver, any function of the device is activated or deactivated through a command corresponding to the MS-supplied driver, where the activated or deactivated function is also selected through the device selection command issued from the GUI and by the user. Step 208, Step 210, Step 212, and Step 230 indicate a procedure of reconfiguring the descriptor of the device while the MS-supplied driver is used. In Step 208, the device selection command is still required to determine a medium for reconfiguring the descriptor. In other words, the medium is also selected through the GUI and by the user. Step 210 indicates a condition that the user selects the MS-supplied driver as the medium for reconfiguring the descriptor so that the MS-supplied driver is used for informing the device to reset. Therefore, previous malfunctioning or unwanted settings of the device are deleted. In Step 212, since previous settings of the device are deleted, the descriptor is reconfigured according to an activated or deactivated function selected by the user, so that settings formed from selections of the user and related to the activated or deactivated function may be applied. In Step 230, when the user selects an API of the operating system as the medium for reconfiguring the descriptor, the API applies settings related to the activated or deactivated function on the device so as to switch required functions of the device.

In Step 214, when the driver selected according to the selected VID/PID is a vendor-supplied driver, a command corresponding to the vendor-supplied driver is required for activating or deactivating any function of the device, where selections about activating or deactivating any function of the devices have been determined along with the device selection command. Step 216, Step 218, Step 220, and Step 230 indicate the procedure of reconfiguring the descriptor of the device while the vendor-supplied driver is used. In Step 216, the medium for reconfiguring the descriptor is also selected according to selections within the device selection command issued by the user. In Step 218, when the command corresponding to the vendor-supplied driver is assigned as the medium for reconfiguring the descriptor, the command is used for informing the device to reset so that previous settings of the device may be completely deleted. And therefore, in Step 220, settings related to activating or deactivating any function of the device may thus be applied on the device. Similarly, when the medium for reconfiguring the descriptor is determined to be the API of the operating system according to selections of the device selection command issued by the user, the API also applies settings related to activating or deactivating any function of the device on the device so as to switch functions of the device.

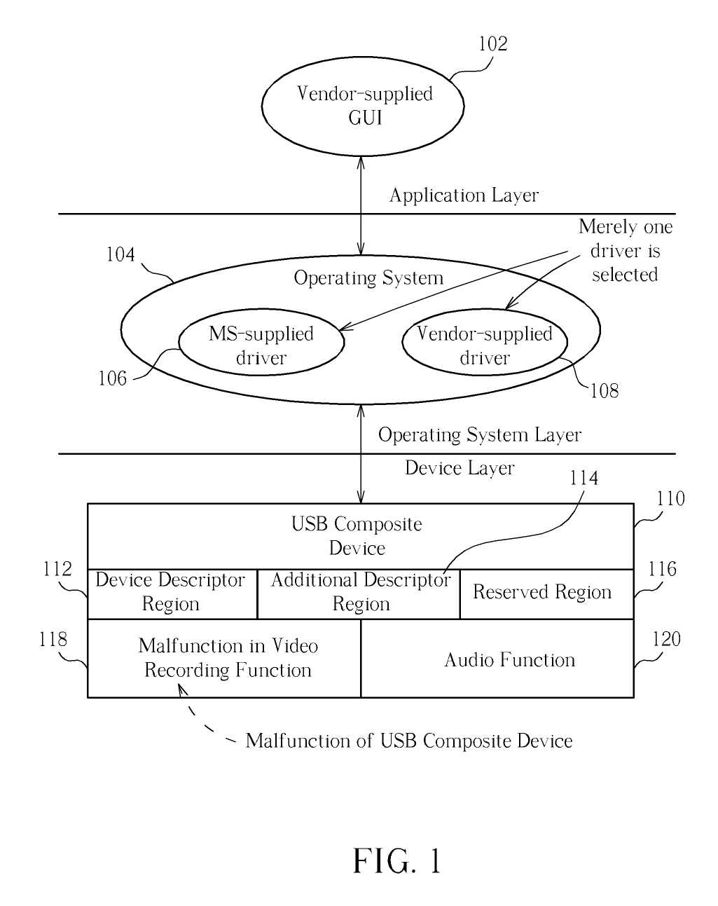

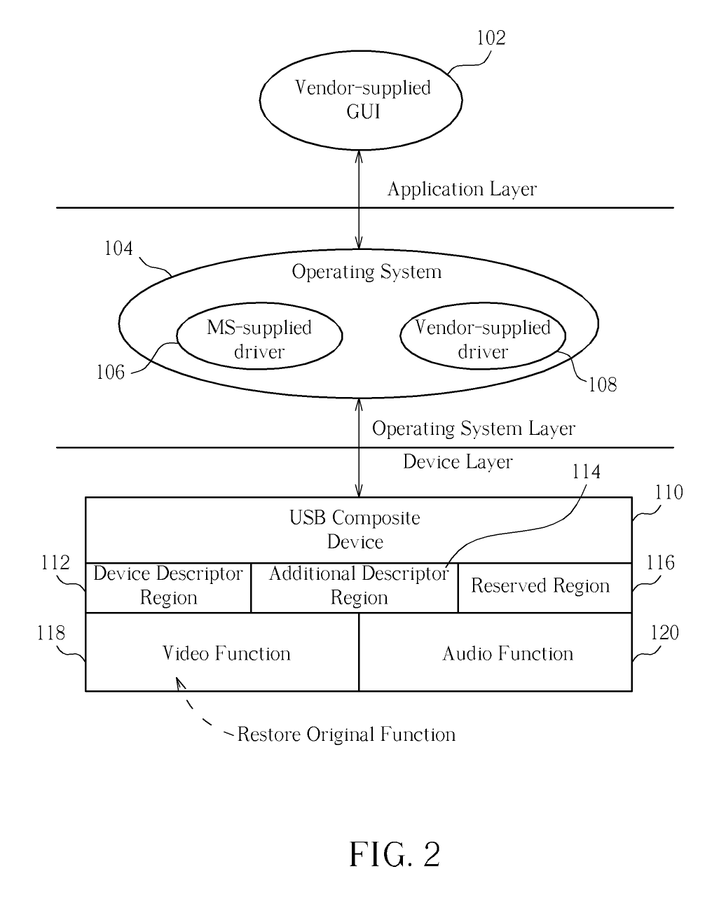

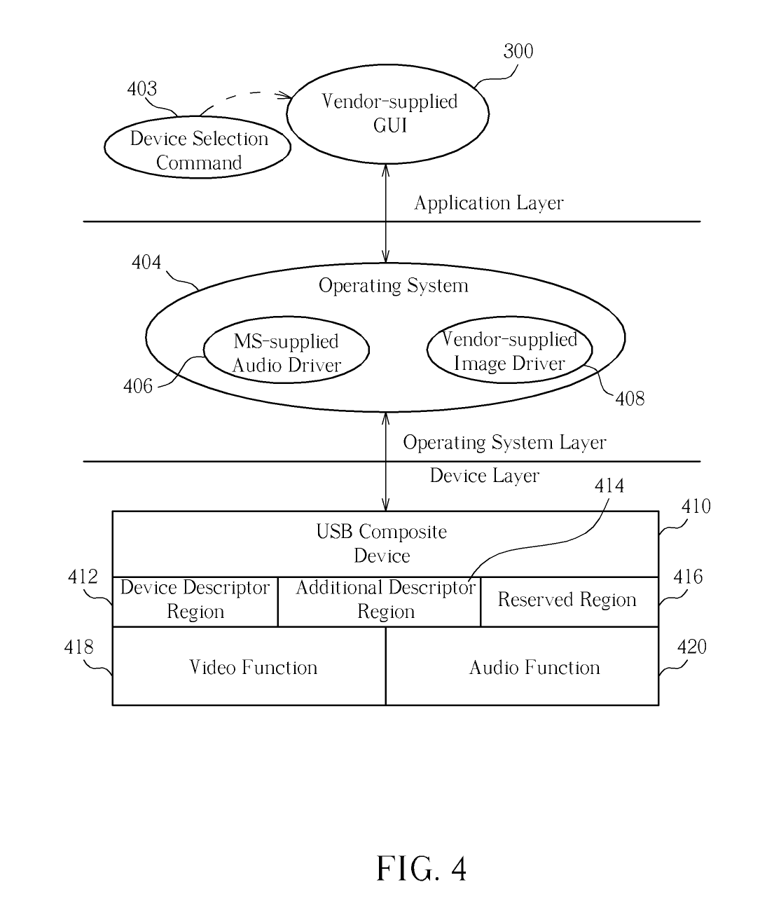

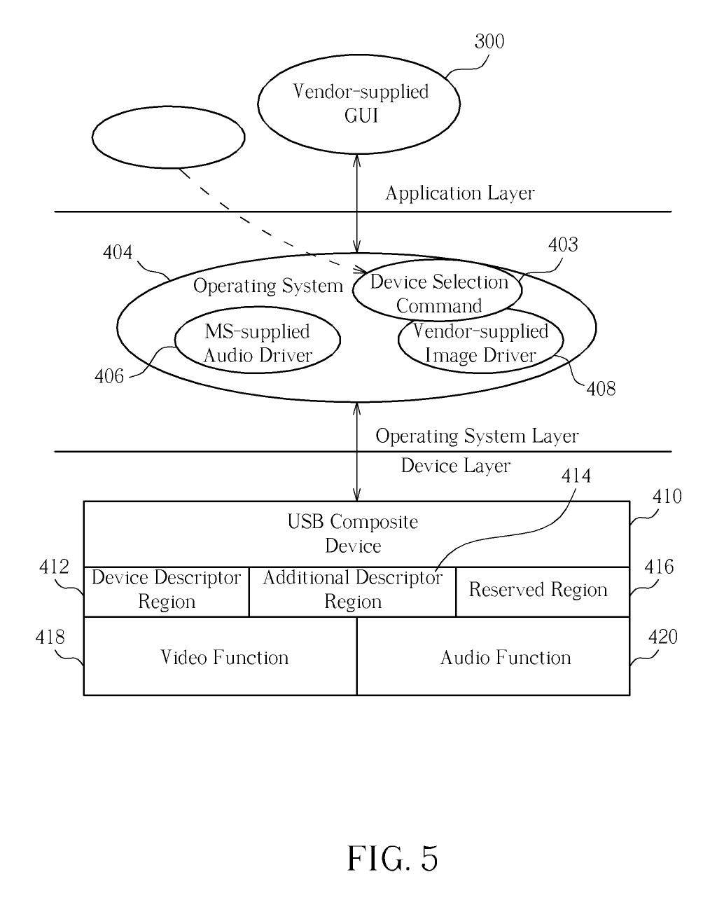

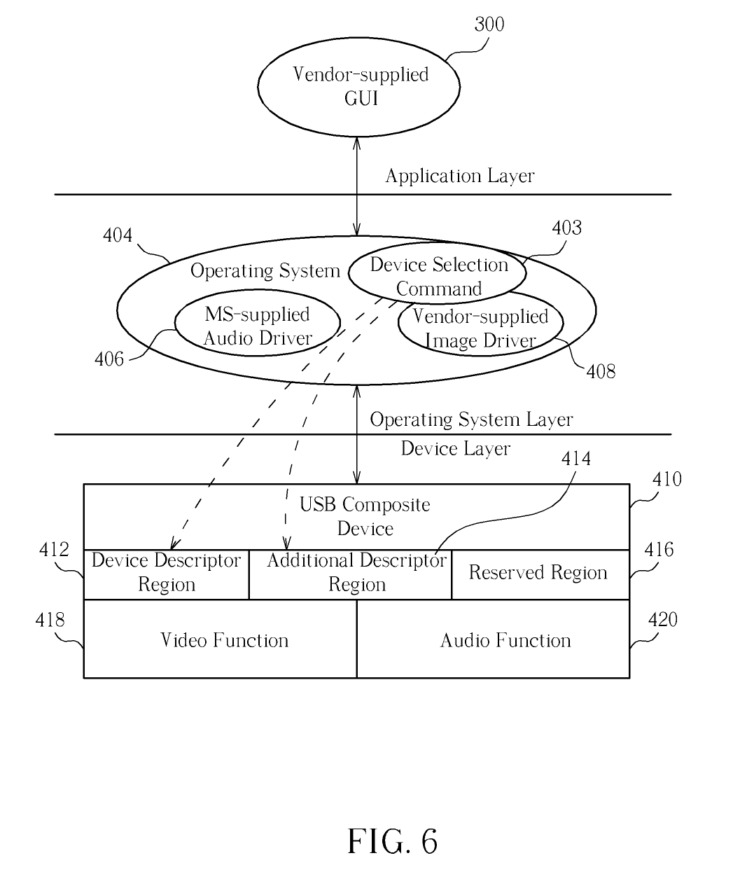

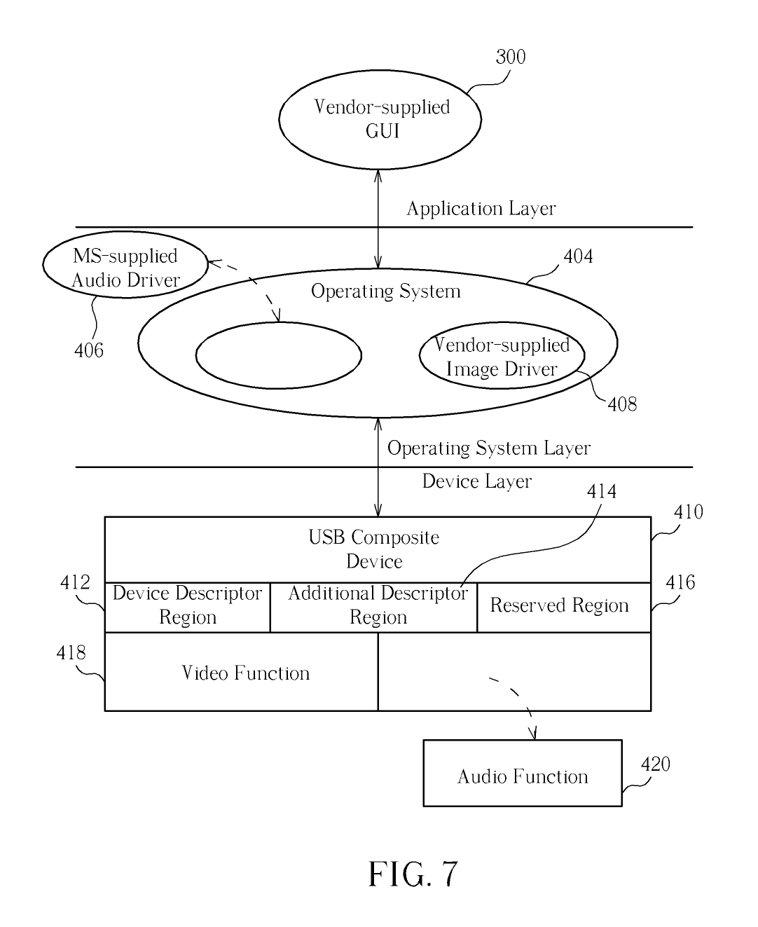

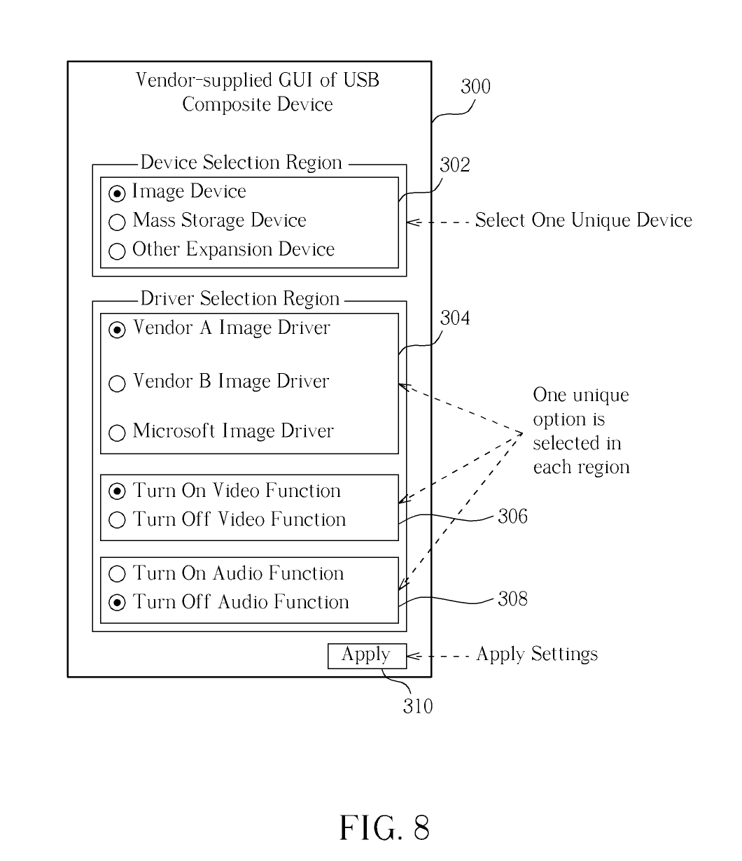

Please refer to FIG. 4, FIG. 5, FIG. 6, and FIG. 7, all of which are diagrams illustrating a condition in which the vendor-supplied driver is determined to be the medium for switching functions of a device according to the disclosed method shown in FIG. 3. Please also refer to FIG. 8, which is a diagram of a vendor-supplied GUI according to both the disclosed method shown in FIG. 3 and a preferred embodiment of the present invention. Most elements illustrated in FIG. 4, FIG. 5, FIG. 6, and FIG. 7 are similar to those shown in FIG. 1, so that repeated elements are not further described herein. Note that in the preferred embodiment of the present invention, the operating system 404 is installed with an MS-supplied audio driver 406 and a vendor-supplied image driver 408. The following descriptions regarding FIG. 4 to FIG. 8 and the preferred embodiment of the present invention are used for more concretely explaining the disclosed method shown in FIG. 3. Note that a vendor-supplied GUI 300 is also illustrated in the form of a block in FIG. 4, FIG. 5, FIG. 6, and FIG. 7 for achieving a better understanding of the preferred embodiment of the present invention.

As shown in FIG. 8, the vendor-supplied GUI 300 includes a device selection region 302, a driver selection region 304, a first function setting region 306, and a second function setting region 308. The device selection region 302 provides functional options including “Image device”, “Mass storage device”, and “Other expansion devices”, where each of the functional options corresponds to a specific VID/PID perceived according to a device descriptor of a USB composite device 410. The driver selection region 304 provides driver options including “Vendor A VID/PID image driver”, “Vendor B VID/PID image driver”, and “Microsoft image driver”. Note that the user is assumed to select the functional option “Image device” in the device selection region 302, so that the driver selection region 304 merely illustrates image drivers related to the functional option “Image device”. Similarly, when the user selects a functional option “Audio device” in another embodiment of the present invention, the driver selection region 304 merely lists audio drivers related to the functional option “Audio device”. As an example, the first function setting region 306 is assumed to be used for setting a function mounted in a first function region 418 shown in FIG. 4 to FIG. 7. Similarly, the second function setting region 308 is used for setting a function mounted in a second function region 420 shown in FIG. 4 to FIG. 7. For example, the first function setting region 306 is assumed to turn on or turn off a video function, and the second function setting region 308 is assumed to turn on or turn off an audio function.

In FIG. 4 and Step 202, the user performs selections on the device selection region 302 of the vendor-supplied GUI 300 shown in FIG. 8 to select a wanted type of peripheral device, and a device selection command 403 is thereby generated and issued. From FIG. 4 to FIG. 7, options including the functional option “Image device” in the device selection region 302, the driver option “Vendor A image driver” in the driver selection region 304 corresponding to the functional option “Image device”, the option “Turn on video function” in the first function setting region 306, and the option “Turn off function” in the second function setting region 308, are assumed to be selected by the user. The vendor-supplied GUI 300 also issues or generates the device selection command 403 according to the selections or settings made by the user. Note that since the device selection command 403 is issued through the vendor-supplied GUI 300 herein, the device selection command 403 at this time may be called a “vendor command.”

In FIG. 5 and Step 240, after the operating system 404 receives the device selection command 403, according to the selection of the functional option “Vendor A image driver”, the vendor A image driver transmits current related settings between the user and the operating system 404 to the USB composite device 410.

In FIG. 6 and Step 214, the USB composite device 410 replaces descriptors of both a device descriptor region 412 and an additional descriptor region 414 according to the activated or deactivated function selected in the received device selection command 403. At this time, settings selected by the users are all completed. However, the selected settings are still required to be applied. Note that functions of the reserved region 416 are the same as those of the reserved region 116 shown in FIG. 1, so that the functions of the reserved region 416 are not further described.

Finally, in FIG. 7 and Step 218, since the user selects the driver option “Vendor A image driver”, the Vendor A image driver informs the USB composite device 410 to reconfigure its descriptors. Therefore, drivers other than the Vendor A image driver, i.e. the Microsoft audio driver, are removed from the operating system 404, so that the USB composite device 410 is reset. According to the abovementioned replacements of the drivers, descriptors within both the device descriptor region 412 and the additional descriptor region 414 are reconfigured by the operating system 404, so that functions settings related to the device selection command are applied to the USB composite device 410. At this time, the audio function installed in the second function region 420 is also removed, so that the second function region 420 does not have any function installed.

In the preferred embodiment shown in FIG. 4, FIG. 5, FIG. 6, and FIG. 7, the updated descriptors may have the USB composite device 410 uniquely support the video function, and have the USB composite device 410 mount any vendor-supplied driver other than the MS-supplied drivers. In other words, with the aid of the vendor-supplied GUI 300 programmed according to the disclosed method of the present invention, while switching operating systems related to different platforms, an updated operating system may thus be fully supported by drivers. When an engineer needs to check or repair the vendor-supplied drivers and related functions, with the aid of the disclosed method of the present invention, required drivers and functions may be remounted or reloaded instantly. For various requirements for functions at any time, different functions of the USB composite device 410 may also be switched instantly. A most significant benefit of the disclosed method of the present invention lies in the fact that the USB composite device 410 is not required to be attached and detached to the USB entirely. Therefore, additional time-consumption is not required anymore for waiting for reconfiguration of the descriptors. Besides, expensive costs in embedding various integrated circuits related to different drivers into a built-in hub within a mainframe are also saved.

Those skilled in the art will readily observe that numerous modifications and alterations of the device and method may be made while retaining the teachings of the invention.

What is claimed is:

1. A method of switching functions of a device without attaching and detaching the device, the method applied on a condition that the device has been attached on a universal serial bus (USB), the method comprising:
selecting a VID (Vendor Identification)/PID (Product Identification) according to a device selection command, a descriptor of the device, and a plurality of VID/PIDs, and selecting a driver corresponding to the selected VID/PID;
determining whether the selected driver is a local driver or an external driver;
activating or deactivating a function of the device through commands corresponding to the local driver while the selected driver is the local driver, wherein the activated or deactivated function is selected according to the device selection command;
determining a medium for reconfiguring the descriptor according to the device selection command; and
reconfiguring the descriptor according to the activated or deactivated function.

2. The method of claim 1 wherein determining the medium for reconfiguring the descriptor according to the device selection command comprises:
determining the local driver to be the medium; and
informing the device to reset through the local driver.

3. The method of claim 1 wherein determining the medium for reconfiguring the descriptor according to the device selection command comprises:
determining an application program interface (API) of an operating system to be the medium.

4. The method of claim 3 wherein reconfiguring the descriptor according to the activated or deactivated function comprises:
reconfiguring the descriptor according to the application program interface of the operating system and the activated or deactivated function.

5. The method of claim 1 further comprising:
activating or deactivating a function of the device through a command corresponding to the external driver while the driver is the external driver;
wherein the activated or deactivated function is selected according to the device selection command.

6. The method of claim 5 wherein determining the medium for reconfiguring the descriptor according to the device selection command comprises:
determining the command corresponding to the external driver to be the medium; and
informing the device to reset through the command corresponding to the external driver.

7. The method of claim 5 wherein determining the medium for reconfiguring the descriptor according to the device selection command comprises:
determining the application program interface of the operating system to be the medium.

8. The method of claim 7 wherein reconfiguring the descriptor according to the activated or deactivated function comprises:
reconfiguring the descriptor according to the application program interface of the operating system and the activated or inactivated function.

9. The method of claim 1 wherein the local driver is provided by a Microsoft operating system, and the universal serial bus is controlled by the Microsoft operating system.

10. The method of claim 1 wherein the device selection command is issued by a user through a graphical user interface (GUI) provided by a vendor corresponding to the device.

11. The method of claim 1 wherein types of the device comprise an image device, a mass storage device, or an expansion device; wherein the types of the device correspond to functions provided by the device.
